(19) United States
(12) Patent Application Publication
(10) Pub. No.: US 2022/0006876 A1
(43) Pub. Date: Jan. 6, 2022

(54) UNIVERSAL CONVERTOR, FEEDERS AND PUSHERS FOR CONNECTIVITY OF INDUSTRIAL INTERNET OF THINGS

(71) Applicant: Siraj Technologies Ltd., Beer Sheva (IL)

(72) Inventor: Yussif ALSANAH, Lakiya (IL)

(73) Assignee: Siraj Technologies Ltd., Beer Sheva (IL)

(21) Appl. No.: 17/478,553

(22) Filed: Sep. 17, 2021

Related U.S. Application Data
(63) Continuation of application No. PCT/US2020/023329, filed on Mar. 18, 2020.
(60) Provisional application No. 62/819,956, filed on Mar. 18, 2019.
(60) Provisional application No. 62/819,959, filed on Mar. 18, 2019.

(51) Int. Cl. H04L 29/08; G16Y 40/10

(52) U.S. Cl. CPC H04L 67/2823; G16Y 40/10; H04L 67/18; H04L 67/12

(57) ABSTRACT

A data conversion method and system are provided. The method includes receiving a data from a feeder, the feeder configured to provide the data from data generating element, generating a schema in response to the received data; merging the generated schema with a previously generated schema to update a dictionary, and deploying the dictionary within a universal converter, upon determining that: the dictionary is unchanged, and a learning conducted by a learning machine satisfies a predetermined value.

### CROSS-REFERENCE TO RELATED APPLICATIONS

### Technical Field

The disclosed embodiments generally relates to systems having a plurality of data generating elements, and more particularly to systems including components that enable the transfer of data from the data generating elements to a cloud-based central processing element, and more particularly by using a series of elements including building blocks that convert protocols and data formats.

### BACKGROUND

A system, for example an industrial system, may include a plurality of end-point equipment that may have one or more data generating elements associated thereto. Such data generating elements may be generating data respective of such end-point equipment. The data may be collected for the purpose of monitoring and/or controlling particular end-point equipment. For example, a sensor may be connected to a motor to check the number of Revolutions-Per-Minute (RPM) every predetermined period of time. The data collected by the sensor may be used to make determinations respective of the motor. The data provided by such a sensor has two aspects to it. That is, the sensor typically provides the data in a particular data format. Also, the data is transferred from the sensor onwards using a particular protocol. Such a protocol may be a communication protocol, such as Ethernet or Internet protocols, Bluetooth®, WiFi®, serial or parallel protocols, and the like. In addition, memory transfer protocols may also be used. That is, data is placed in a particular location in a memory unit and then used by another element for processing purposes.

In a typical industrial system, there may be many different data generating elements each having its particular data format and its particular transfer protocol. Today, as cloud based processing becomes prevalent and desirable for a variety of reasons, the onboarding of data generated from a plurality of data generating elements to the cloud has become a necessity. The process requires two steps, one is the definition of the access to the data, (i.e., the protocols), and the other is the adaptation of the data format used by Data Generating Elements (DGEs) to data formats used by the cloud processing elements.

Typically, both of these steps are performed by adaptors that are provided on a per data generating element, as shown, for example, with reference of FIG. 1. Basically, a system 105 comprises an industrial system 130 that may be equipped with a plurality of Data Generating Elements (DGEs) 140-1 through 140-N (collectively described as DGE 140 or DGEs 140 hereinafter), where N is an integer number. The DGEs 140 may be sensors, time stamp devices, and any other kind of elements that generate data respective of the industrial system 130. The data collected by each of the DGEs 140 is transferred via a gateway 150 to a network 110, which is connected to one or more Cloud Service Providers (CSPs) 120.

For example, CSPs 120-1 through 120-M (collectively described as CSP 120 or CSPs 120 hereinafter), where M is an integer. In order for each DGE 140 to operate in conjunction with the respective CSP 120, each has to have a corresponding adaptor to properly function. The adaptors 155, (e.g., adaptors 155-1 through 155-N, which will be collectively described as adapter 155 or adapters 155 hereinafter), may be part of the gateway 150 that connects between the DGEs 140 and the network 110. The network 110 may be wired or wireless, and may include but is not limited to Local Area Network (LAN), Wide Area Network (WAN), Metro Area Network (MAN), Worldwide Web (WWW), the Internet, and any combinations thereof.

In an example, the adaptors 155 may interact with three DGEs 140, DGE 140-1, DGE 140-2 and DGE-140-3, with each DGE 140 having its particular characteristics. DGE 140-1 and DGE 140-3 may provide a data format of 32-bit time stamp, while DGE 140-2 may provide a data format of 64-bit time stamp. In addition, DGEs 140-1 and 140-2 operate using a TCP/IP communication protocol while DGE 140-3 operates using a Structured Query Language database (SQL-DB) protocol. As a result, three different adaptors are necessary, each particularly tailored for the needs of each case.

Furthermore, FIG. 2A shows the different conversions used in an adaptor 155-1, operative in conjunction with a DGE 140-1. The adaptor 155-1 includes convert 32-bit time stamp data, convert Message Queuing Telemetry Transport (MQTT) data, convert data to net protocol, and finally provide access to the gateway 150 using TCP/IP.

FIG. 2B shows the different conversions used in adaptor 155-2, operative in conjunction with DGE 140-2, that includes convert 64-bit time stamp data, convert Simple (or Streaming) Text Oriented Message Protocol (STOMP) data, convert data to net protocol, and finally provide access to the gateway 150 using TCP/IP. Finally, FIG. 2C shows the conversions used in adaptor 155-3, operative in conjunction with DGE 140-3 that converts the 32-bit data time stamp and then provides access to the gateway 150 on an SQL-DB protocol.

Considering that many of the data generating elements in the field of industrial systems have been conceived and implemented prior to the development of cloud-based connectivity, and a lack of standardization, there are many possible different configurations. This requires manual generation of each adaptor 155 to fit each case. As a result, a large number of configurations result from the number of possibilities for data c through a gateway, the number of data format conversions, and the number of adaptations necessary between the data generating element and the processing element in the cloud.

When considering the number of data conversions needed to support (typically 200 or more), the number of conversions (typically 2 or more), the number of data access possibilities (typically 500 or more), and the number of cloud environments (typically 10 or more), the number of resulting adaptor configuration possibilities is 200 million or more. This makes the manual solution for development of adaptors expensive, inefficient, and time consuming.

It is therefore desirable to provide a solution that will overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for data conversion. The method includes receiving a data from a feeder, the feeder configured to provide the data from data generating element, generating a schema in response to the received data; merging the generated schema with a previously generated schema to update a dictionary, and deploying the dictionary within a universal converter, upon determining that the dictionary is unchanged, and a learning conducted by a learning machine satisfies a predetermined value.

Certain embodiments disclosed herein also include a system for data conversion system. The system includes a data generating element configured to generate data, and a container configured to the data generating element, the container enabling the generated data to be delivered to a computing component and including a feeder configured to accept the generated data and transfer the generated data to the converter in a first data format of a plurality of data formats, a converter coupled to the feeder and configured to convert the first data format to the second data format, and a pusher coupled to the converter, and configured to transfer data in a second format from the plurality of data formats provided by the converter to a service provider.

Certain embodiments disclosed herein also include A universal converter system, including a processing circuitry, and a memory, the memory containing instructions that, when executed by the processing circuitry, configure the system to receive a data from a feeder, the feeder configured to provide the data from a data generating element, generate a schema in response to the received data, merge the generated schema with a previously generated schema to update a dictionary, and deploy the dictionary within a universal converter, upon determining that the dictionary is deployable, and a learning period by a learning machine is sufficiently long.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system for transmission of data from an industrial system through a data generating elements each element connected by a hard-coded adaptor to the cloud.

FIG. 2A is a schematic diagram of adaptor conversion in a first exemplary case.

FIG. 2B is a schematic diagram of adaptor conversion in a second exemplary case.

FIG. 2C is a schematic diagram of adaptor conversion in a third exemplary case.

FIG. 3 is a schematic diagram of system for transmission of data from an industrial system through a gateway configured using a plurality of building blocks according to an embodiment.

FIG. 4 is a schematic diagram of a system adapted for transmission of data from an industrial system and configured with a plurality of feeders and pushers that connect through a universal converter according to an embodiment.

FIG. 5 is a flowchart for generating a dictionary for a universal converter according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Typically, with many different Data Generating Elements (DGE) having a large variety of configurations it is necessary to develop many different adaptors in order to enable the necessary connectivity. In typical systems, there may be a need for dozens of feeders and pushers. This means that the number of converters that connect between them grows exponentially. Therefore, the use of a single type of a universal converter is implemented so that a plurality of feeders and a plurality of pushers connect to the same universal converter. The universal adaptor is typically created by learning the behavior of the system with respect of the feeders and the pushers.

In the world of Internet of Things (IOT) in general and in particular the world of Industrial IOT (IOT) there is a growing need to connect DGEs to standard processing capabilities in the cloud. Such connection in general, and in particular with respect to legacy DGEs presents challenges that require protocol and data format conversions. A universal converter converts data formats, from a plurality of DGEs, to a plurality of other standard data formats useable by the processing elements on the cloud. The universal includes, after a period of learning of the language communicated by the DGEs, an industrial system that performs the learning period until such time that a long enough period passes without new learning to be conducted. Thereafter the universal converter is used between feeders and pushers to perform the necessary data format conversions using a learned dictionary. The advent of IOT has also raised the need for connecting DGE) in industrial applications, which also known as IOT.

In one embodiment rather than tailoring adaptors 155, three types of building blocks are used in order to create all adaptors required to interface a DGE 140 to a CSP 120. A first type of building blocks used are data feeders, referred to shortly herein as feeders. The feeders are responsible for the access to the data. A feeder may include, but is not limited to, a file feeder, a Transmission Control Protocol/Internet Protocol (TCP/IP) feeder, an Interlayer Collaboration Protocol (ILC) feeder, and (Structured Query Language (SQL) feeder, a Peripheral Component Interconnect (PCI) feeder, and the like. A second type of building blocks is the data converters, or converters as used herein for short. A converter may include, but is not limited to, a 32-bit time stamp, a 64 bit time stamp, a Mudbus, an MQTT, a Streaming Text Oriented Messaging Protocol (STOMP), and the like. A third type of building blocks is the data pusher, or the pusher for short. These are building blocks that enable the interface to a particular Cloud Service Provider (CSP) 120, for example a pusher that pushes the data to.

An adaptor, according to the disclosed embodiments, includes building blocks, each adaptor includes one feeder, one or more converters and one pusher. Furthermore, building blocks may be shared. That is, a building block may be used by more than one DGE or more than one other building block. For example, a TCP/IP feeder building block may be used by two or more DGEs that interface using this protocol. A 32-bit time stamp converter may be used by both an SQL-DB feeder as well as an MQTT converter.

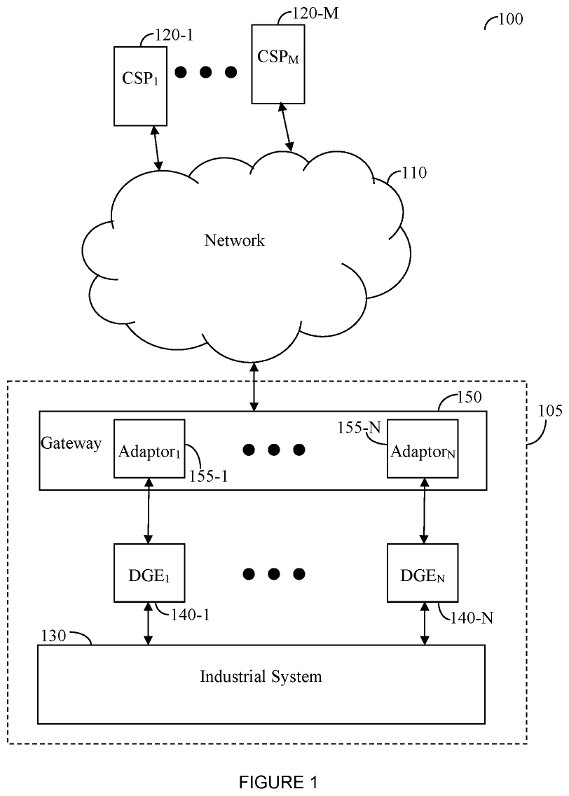

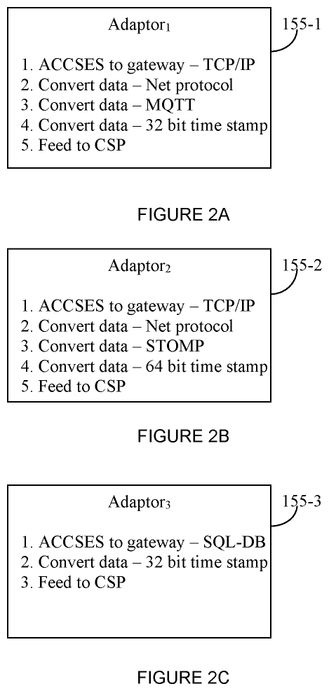

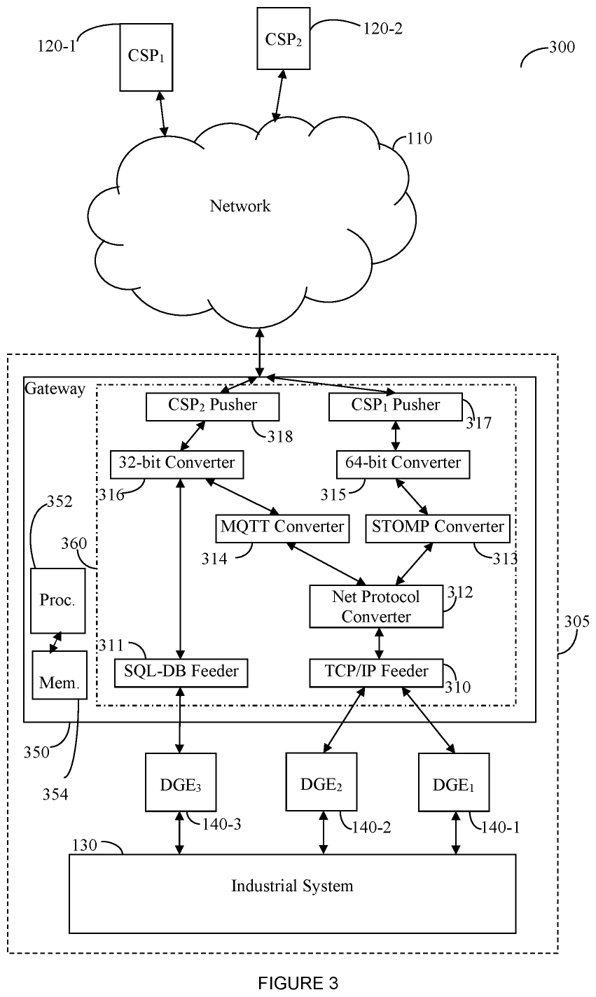

FIG. 3 is an example block diagram 300 of a system 305 configured for transmission of data from an industrial system 130 through a gateway 350 that uses a plurality of building blocks according to an embodiment. Similar elements in FIG. 3 that are previously shown in FIG. 1, and which have the same function are not described herein again. In the embodiment, FIG. 3 includes two CSPs 121-2 (which will be collectively referred to CSP 120 or CSPs 120), three DGEs 141-3 (which will be collectively referred to DGE 140 or DGEs 140).

In an embodiment, the adaptors (e.g., adaptors 155-1 through 155-N of the gateway 150 previously shown in FIG. 1) are replaced by a container 360 having therein a plurality of building blocks. The plurality of building blocks includes various adaptors that are explained herein, using certain building blocks for more than one adaptor. The gateway 350 may include a processing unit 352 and a memory 354 attached thereto, where the memory contains instructions therein that when executed by the processing unit realize the container 360 described herein.

A first adaptor is achieved for a Data Generating Element (DGE) 140-1 that provides a 32-bit time stamp using a Transmission Control Protocol/Internet Protocol (TCP/IP) protocol, the data of which is to be handled by a first Cloud Service Provider (CSP) 120-1 (where the CSP can also be known as a cloud processing element). A TCP-IP feeder 310 is configured to connect DGE 140-1 to a network protocol converter 312. The network protocol converter 312 is further configured to connect to a Messaging and Queuing Telemetry Transport (MQTT) converter 314, which in turns connects to a 32-bit time stamp converter 316. As it is necessary to transfer this data to the CSP 120-1, the 32-bit time stamp converter 316 connects to a second CSP pusher 318.

A second adaptor is achieved for a DGE 140-2 that provides a 64-bit time stamp using a TCP/IP protocol, the data of which is to be handled by the first CSP 120-1. A TCP-IP feeder 310 connects DGE 140-2 to the net protocol converter 312. For this case, the net protocol converter 312 is configured to connect to a Streaming Text Oriented Messaging Protocol (STOMP) converter 13, which in turn connects to a 64-bit time stamp converter 315. As it is necessary to transfer this data to CSP 120-1, the 64-bit time stamp converter 315 connects to a first CSP pusher 317.

Additionally, a third adaptor is achieved for DGE 140-3 that provides a 32-bit timestamp to be handled by a second CSP 120-2. An SQL-DB feeder 311 connects to DGE 140-3 and transfers data to the 32-bit time stamp converter 316. As it is necessary to transfer this data to CSP 120-2, the 32-bit time stamp converter 316 connects to the second CSP pusher 318. By reusing building block elements, a modular design of adaptors is achieved. One of ordinary skill in the art would readily appreciate the difference between a system having a large number of tailor-coded adaptors, and a system where the adaptors are modular, and would take advantage of reusing building blocks.

A data converter system, according to the embodiment, includes a data generating element that generates data, and a container configured to communicate with the data generating element. The container enables the generated data to be delivered to the computing component and includes a feeder, a converter coupled to the feeder, and a pusher coupled to the converter. The feeder is configured to accept the generated data and transfer the generated data to the converter in a first data format of a plurality of data formats. Also, the pusher is configured to transfer data in a second format from the plurality of data formats provided by the converter to a service provider. Further, the converter is configured to convert the first data format to the second data format.

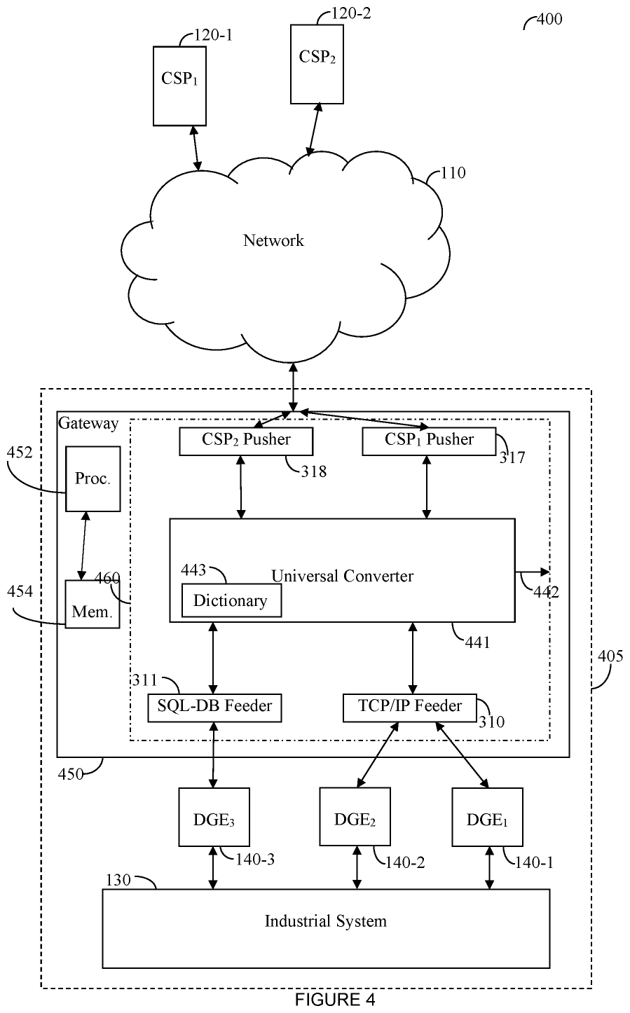

It should be noted that the number of converters may grow exponentially as there are many possible permutations as each manufacturer of the DGE 140 may be using proprietary data formats. Therefore, the number of converters that may be needed to serve all the different permutations of pushers and feeders may be infinite. Therefore, coverage of the different permutations can be low, and it is impractical to expect hand-tailored development of converters for the container 360. As such it would be advantageous not to have any converter at all by providing a universal converter as will be described in the exemplary FIG. 4 below.

FIG. 4 is an example schematic diagram 400 of a system 405 adapted for transmission of data from an industrial system and configured with a gateway 450 that includes a plurality feeders and pushers that connect through a universal converter according to an embodiment. Compared to FIG. 3, similar components of FIG. 4 are similarly marked. FIG. 4 additionally includes a universal converter 441 that provides an interface between a plurality of feeders, (e.g., feeders 310 and 311), and a plurality of pushers, (e.g., pushers 317 and 318). A dictionary 443 is also included within the universal converter 441. The gateway 450 may include a processing unit 452 and a memory 454 attached thereto, where the memory contains instructions therein that when executed by the processing unit realize the container 460 described herein.

The universal converter 441 is created by initial automated learning of the inputs received from the DGEs 140, selecting the necessary feeders and pushers, and creating the universal converter 441 based on further automated learning. The generated universal converter 441 is configured to convert an input from a feeder, for example feeder 311, to an output for a pusher, for example pusher 317. The conversion may be performed, for example, by processing sets of rules that include the universal converter 441, by a matrix that converts the input to a desired output, by logic in the form of hardware, software, firmware or combination thereof, by a neural network tuned by the learning process, and by other options.

As the universal converter 441 is generated based on the learning process an error signal 442 may be generated to provide an error notification. This can happen in cases where a particular input is not recognized by the universal converter 441 or, if any one of the pushers provides an error notification. In such cases the error signal 442 is generated. Such errors may occur as a result of a data format that is received from any one of the feeder blocks 310/311, but not recognized by the universal converter 441 or the dictionary 443 that has not been updated to recognize the data format.

Such errors may further occur upon providing a data format from the universal converter 441 to any one of the pushers 417/418, and receiving a notification that the data format is unrecognized by the intended pusher 417/418. The error signal 442 may be processed by the industrial system 130, by a CSP 120, or by any other processing means that is adapted to handle error cases. Such an error signal 442 may provide an alert to an operator of the system 400. Alternatively, the error signal 442 may cause the initiation of another learning phase to enhance the universal converter 441 (e.g., by updating the dictionary 443), so that in the future the universal converter 441 may be capable of handling the particular case that caused the error signal 442 in the first place.

In an embodiment, the generation of a universal converter 441 is performed by listening to the outputs of the plurality of feeders 310/311 that provide a plurality of data formats after protocol adaptation. This raw data is provided to a learning machine (not shown) that is configured to listen to the language. By listening to data transferred for a sufficiently long period of time it is possible to create a dictionary 443 that provides the ability to convert the non-standard data formats to standard data formats that may be used by the pushers 317/318. As a result, the universal converter 42 may accept data formats at its inputs, and output therefrom a normalized data format.

Essentially, a set of rules is generated for the use in this conversion. Accordingly, the learning machine is configured to recognize time series data that are typically characterized by at least three elements: an Identification (ID) that identifies the source of the data, a timestamp, and a data value (e.g., time, temperature, current, voltage, etc.). These and other data may be provided by the DGEs 140 to the universal converter 441 through the feeders 310/311. A learning machine is used to generate a function y=f(x) by providing as many values of ‘x’ and ‘y’ as possible so that eventually the learning machine (or for that matter an artificial intelligence machine) may provide a correct prediction of a value ‘y’ from a value ‘x’ provided thereto. The values are then provided to the learning machine as vectors of numbers that are used to generate a dictionary 443 so that the resultant dictionary 443 can predict a proper output from a format that was not known previously to the converter 441.

Additionally, the learning machine may analyze certain characteristics of data values to interpret the data. For example, a sequence of data values that monotonously increases may provide an indication that this is a timestamp, an identification number may be repeated ever so often to indicate data coming from a particular DGE 140, and a value that changes over time but relatively slowly may be indicative of data provided by a temperature sensor. Therefore the learning machine may learn from both the structure and the values of the data provided to it. In some cases, textual data is provided which enables the learning machine to better analyze the data provided.

Eventually, after sufficient learning by the learning machine of the data transferring therethrough, various data formats are learned and the dictionary 443 is generated that provides the necessary translation from the data received to a normalized data structure. In order to ensure that a particular received data structure is well understood it is necessary for the learning machine to listen to a sufficient number of variants of the data structure so as to ensure proper understanding of the data structure. This is because a data structure may have different appearances, for example, the data structure may provide multiple samples but the number of samples may be different each time.

Further, a data structure may be able to provide samples from one or more DGEs 140 and therefore, while using the same data structure, its appearance may be different. Therefore, the learning machine may cover as many as possible permutations of the data structure appearance so that the dictionary 443 can consistently predict the output of the normalized data format.

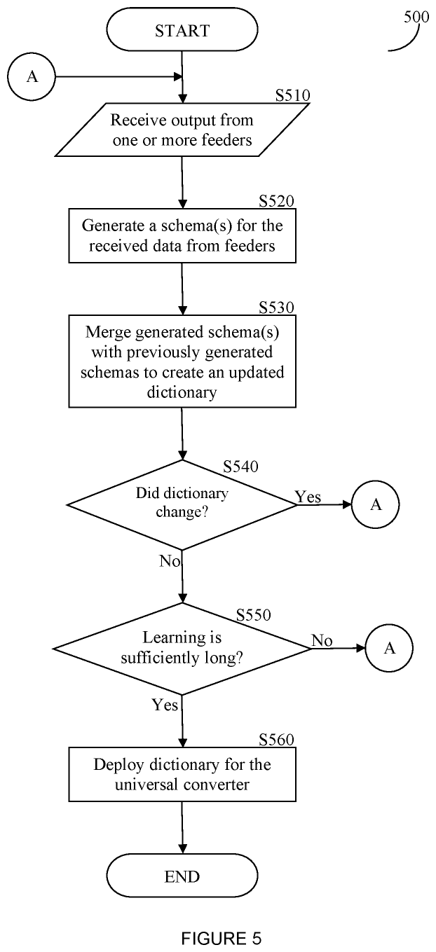

FIG. 5 is an example flowchart 500 for generating a dictionary 443 for a universal converter 441 according to an embodiment. At S510, an output from one or more feeders is received by a learning machine. Next, at S520, one or more schemas are generated by the learning machine in response to the received data formats. Afterwards, in S530, the generated one or more schemas are merged with previously generated schemas so as to generate an updated dictionary 443.

Next, at S540, it is checked whether the dictionary 443 has changed. If the dictionary has changed (i.e., it is not yet stable enough or includes enough schema or data to account for different schema permutations to be deployed for the purpose of being used by the universal converter), execution continues with S510; otherwise, upon determining that the dictionary is unchanged, or is stable enough to be deployed, the flowchart 500 continues with S550. A dictionary that changes often is typically an indication of a dictionary that cannot be used consistently and therefore more learning is required before it can be put to effective use.

At S550 it is checked whether learning by the learning machine has been sufficiently long (i.e., satisfies a predetermined criteria or value). This may be achieved, for example, by the passage of at least a predetermined period of time, a predetermined number of data units received from the feeders, or a predetermined number of feeders providing data. If it is determined in S550 that the check was not long enough based on the parameters checked then execution continues with S510; otherwise execution continues with S560.

At S560, the dictionary 443 is deployed, for example by replacing a previously installed dictionary 443 within the converter 441 or installing the initial dictionary 443 for use by the converter 441. Once the universal converter 441 is adapted to operate with the dictionary 443 received, data format may be converted to normalized data formats. Upon detection of an error, and notification via error signal 442, the learning machine may be reactivated to allow for additional learning and updating of the dictionary 443. According to tests performed, the learning of 10,000 formats by the learning machine provided a dictionary 443 with a 99.98% accuracy of translation.

It should be appreciated that while a single universal converter 441 is described, an embodiment that includes a plurality of universal converters 441 is also possible. Such use of a plurality of universal converters 441 may be used to enhance implantation efficiency and response time of the universal converter 441, minimize intersection between at least two groups of DGEs 140, and the like.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for data conversion, comprising:
receiving a data from a feeder, the feeder configured to provide the data from data generating element;
generating a schema in response to the received data;
merging the generated schema with a previously generated schema to update a dictionary; and
deploying the dictionary within a universal converter, upon determining that:
the dictionary is unchanged; and
a learning conducted by a learning machine satisfies a predetermined value.

2. The method of claim 1, wherein the dictionary is determined to be unchanged upon determining that the dictionary is stable enough to be deployed.

3. The method of claim 1, where the predetermined value includes one of a passage of a predetermined period of time, a predetermined number of data units has been received from the feeder, or a predetermined number of feeders providing data.

4. The method of claim 1, wherein the dictionary is deployed by replacing a previously installed dictionary within the converter.

5. The method of claim 1, wherein the dictionary is configured to provide a conversion of the received data to a normalized data for transfer to a pusher.

6. The method of claim 5, further comprising:
normalizing data to a cloud processing element using a predetermined communication protocol and a predetermined data format.

7. The method of claim 5, further comprising:
providing an error notification in response to receiving unsupported data from the feeder.

8. The method of claim 5, further comprising:
providing an error notification to indicate that an error was received by the pusher.

9. The method of claim 5, further comprising:
updating the dictionary upon determining that an error is a result of a need to update the dictionary.

10. A data conversion system, comprising:
a data generating element configured to generate data; and
a container configured to the data generating element, the container enabling the generated data to be delivered to a computing component and including:
a feeder configured to accept the generated data and transfer the generated data to the converter in a first data format of a plurality of data formats;
a converter coupled to the feeder and configured to convert the first data format to the second data format; and
a pusher coupled to the converter, and configured to transfer data in a second format from the plurality of data formats provided by the converter to a service provider.

11. The data conversion system of claim 10, wherein the converter is a universal converter configured to provide an error notification in response to receiving an unsupported data format from the feeder.

12. The data conversion system of claim 10, wherein the converter comprises: a plurality of converters including one of a Messaging and Queuing Telemetry Transport (MQTT) converter, a streaming text oriented messaging protocol (STOMP) converter, or a network protocol converter.

13. The data conversion system of claim 11, wherein the error notification indicates an unidentified data format that is received from the feeder.

14. The industrial system of claim 11, wherein the error notification is provided to the pusher by the converter.

15. A universal converter system, comprising:
a processing circuitry; and
a memory, the memory containing instructions that, when executed by the processing circuitry, configure the system to:
receive a data from a feeder, the feeder configured to provide the data from a data generating element;
generate a schema in response to the received data;
merge the generated schema with a previously generated schema to update a dictionary; and
deploy the dictionary within a universal converter, upon determining that:
the dictionary is deployable; and
a learning period by a learning machine is sufficiently long.

16. The universal converter system of claim 15, wherein the dictionary is configured to:
provide a conversion of the received data to a normalized data for transfer to a pusher.

17. The universal converter of claim 16, wherein the pusher is configured to:
provide the normalized data to a cloud processing element using a predetermined communication protocol and a predetermined data format.

18. The universal converter of claim 15, wherein the universal converter is further configured to:
provide an error notification in response to receiving unsupported data from the feeder.

19. The universal converter of claim 16, wherein the universal converter is further configured to:
provide an error notification to indicate that an error was received by the pusher.

20. The universal converter of claim 16, wherein the universal converter is further configured to:
update the dictionary upon determining that an error is a result of a need to update the dictionary.
